(19) United States
(12) Patent Application Publication
(10) Pub. No.: US 2004/0260454 A1
(43) Pub. Date: Dec. 23, 2004

(54) Vibro-acoustic engine diagnostic system

(76) Inventor: Otman A. Basir, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 10/867,281

(22) Filed: Jun. 14, 2004

Related U.S. Application Data
(60) Provisional application No. 60/477,670, filed on Jun. 11, 2003.

(51) Int. Cl. G06G 7/70; G06F 19/00

(52) U.S. Cl. 701/111; 701/114

(57) ABSTRACT

A diagnostic system is used for detecting the health condition of moving internal mechanical components in internal combustion engines. The system uses measurements of engine vibration and acoustic signals during cold or hot engine test. The system includes engine vibration and acoustic sensing, engine vacuum sensing, signal conditioning and pre-filtering, analog to digital conversion, advanced digital signal processing, and decision making. Engine vibration and acoustic signals are first amplified and then passed through a low-pass filter. The signals are then digitized and sent to a computer. An engine diagnostic software receives the digitized data and performs digital filtering to isolate signal parts that most influenced by each engine moving mechanical component of interest. Features are then extracted using statistical analysis and passed to a decision making inferences. The decision making inferences utilize fuzzy logic engines to fuse feature values and reach a conclusive decision about each component condition. The system is then summarizes all results and presents them to the operator.

This application claims priority to U.S. Ser. No. 60/477,670 filed Jun. 11, 2003.

### BACKGROUND OF THE INVENTION

1. Field of the Invention

The present invention is related, in general, to a method for detecting faults in internal combustion engines based on time-frequency analysis of the engine vibration and acoustic measurements.

2. Background Art

Manufacturing of reliable engines requires thorough testing of each produced engine. The testing process should be performed quickly and accurately. Currently, engine manufacturers rely on expert technicians to evaluate engine health condition. These technicians use their hearing sense and knowledge of engine fault noise characteristics to screen out any faulty engine. Such knowledge is gained by practice and experience, thus, makes the inspection process efficiency depends on the technicians' experience level. This creates a production bottleneck if an inadequate number of expert technicians is available. Moreover, with the large number of produced engines, human experts, who are subjective in nature, would lack consistency and focus.

Such an obstacle may be overcome by utilizing an automated diagnostic system based on engine acoustic and vibration analysis. Such a system can be consistent and hence increases reliability. This in turn reduces manufacturer warranty costs and improves customer satisfaction. In fact such a system can be used to diagnose engine faults that human experts may easily miss. A similar diagnostic system can be installed in automobiles, trucks, and even larger engines for on-line engine condition monitoring. The system could detect engine malfunctions including mechanical faults and those responsible for rise in engine emission output such as engine misfire.

Faults in internal combustion engines can be classified into two groups, namely combustion and mechanical faults. Examples of these faults are misfiring, knocking, valve leakage (intake and exhaust), fuel leakage or shorting, cylinder ring gumming, cylinder ringing, bearing wear, gear damage, worn timing belt, etc. Since all faults are related to excitation events, faults would alter the force-time profile of the excitation associated with that moving element or event. As such, faults are expected to manifest themselves in the engine vibration and sound signatures. However, detecting small faults is limited by the signal to noise ratio, signal path attenuation factor, and the discrimination ability of the selected diagnostic technique.

In the past, many researchers have succeeded in detecting small faults in bearings and gears using time and frequency domain analysis techniques. Examples of these techniques are time synchronous, kurtosis, power spectrum analysis, amplitude and phase modulation, and cepstrum. However, these techniques are not suitable for engine diagnostics, as engine vibration signature is non-stationary in nature. On the other hand these techniques can be used to detect engine bearing and gear conditions once their associated signals are isolated effectively from the overall engine signal. Consequently, engine diagnostic researchers have focused on techniques that would have time and frequency capabilities. A number of time-frequency techniques have been applied in the area of engine diagnostics, for example, gated vibration analysis, and wavelet analysis. However, most of these techniques are used in engine noise analysis or for a specific combustion related faults such as over-fueling or piston slapping.

Most of the previous engine diagnostic techniques do not focus on each individual element to check their health condition but rather try to assess the overall (or for selected frequency bands) vibration and define a threshold. In some other techniques only a specific engine component is being considered, for example, the U.S. Pat. No. 4,483,185 discloses a valve clearance diagnostic technique that uses an analog filter and a gate circuit. Other techniques used engine pressure sensory information as measured at the engine intake and exhaust manifolds during engine cold testing. One example is disclosed in the U.S. Pat. No. 6,481,269 in which a group of points are identified on the intake and exhaust pressure waveform. The suggested technique compares the locations and values of these points to reference ones that are identified from a good engine or specified by a designer. Such a technique would be very sensitive to variations in engine pressure waveforms due to manufacturing tolerances in engine elements.

### SUMMARY OF THE INVENTION

The engine diagnostic system according to the present invention is used as a part of a quality control assurance cell in internal combustion assembly line. The cell is usually situated at the end of the assembly line to perform either cold or hot engine tests. Some engine manufacturers may prefer allocating the test cell within the assembly line to test the main engine mechanical components alone. In cold testing the engine is driven by an electric motor at constant speed. However, hot testing is performed only on completely assembled engines.

The engine diagnostic system and method according to the present invention consists of three main components and steps: signal acquisition and pre-processing, signal isolation and enhancement, and fault detection and classification. First, unrelated engine signals are filtered out, and subsequently, signals that are related to individual engine elements are isolated using digital filters. The frequency bands of the digital filters are selected based on off-line time-frequency analysis of the sound and vibration signals of the specific engine. Each frequency band is selected such that the filtered signal is dominated by responses from a certain mechanical component of interest in the engine. For example, in a small single piston engine, the gear's response is in the range of 1000 Hz to 4000 Hz, however, the valve's response is in the range of 11000 Hz to 13000 Hz. Next, features are extracted from the filtered signals using statistical analysis.

In the case of cold testing, vacuum sensors are used to enhance the detection of faults in valve clearances and timing. Features are then extracted from the vacuum waveforms using measurements of key points on the waveform. These measurements are calculated with respect to a reference point within the vacuum waveform itself. Vibro-acoustic and vacuum based features are then fused using a decision-making algorithm to reach a verdict about the specific component health condition.

### BRIEF DESCRIPTION OF THE DRAWINGS

The various features and advantages of the present invention will become apparent to those skilled in the art by referring to the following detailed description and drawing in which:

FIG. 1 is a schematic diagram of an engine diagnostic system in accordance with a preferred embodiment of the present invention;

FIG. 2 is a schematic block diagram illustrating the engine diagnostic software components according to the present invention;

FIG. 3 is a schematic block diagram of a vibro-acoustic fault detection bank in accordance with step 32 of FIG. 2;

FIG. 4 is a schematic block diagram of the valve peak detector in accordance with step 54 of FIG. 3;

FIG. 5 is a schematic block diagram of the piston oil ring detector in accordance with step 60 of FIG. 3;

FIG. 6a is a graphical representation of the displacement curves of the intake and exhaust valves of a single piston engine;

FIG. 6b is a graphical representation of a filtered signal in the frequency range that signifies the valve response;

FIG. 6c is a graphical representation of the moving variance of the signal in FIG. 6b;

FIG. 6d is a graphical representation of an engine piston speed;

FIG. 6e is a graphical representation of a filtered signal in the frequency range that signifies the piston oil ring response;

FIG. 6f is a graphical representation of the moving variance of the signal in FIG. 6e;

FIG. 7 is a schematic block diagram of a vacuum fault detection bank in accordance with step 107 of FIG. 2;

FIG. 8a is a graphical representation of the displacement curves of the intake and exhaust valves of a single piston engine;

FIG. 8b is a graphical representation of an intake vacuum waveform of a single-piston engine;

FIG. 8c is a graphical representation of an exhaust vacuum waveform of a single-piston; and

FIG. 9 includes the health condition inferences of all engine elements of interest in accordance with step 39 in FIG. 2.

### DETAILED DESCRIPTION OF A PREFERRED EMBODIMENT

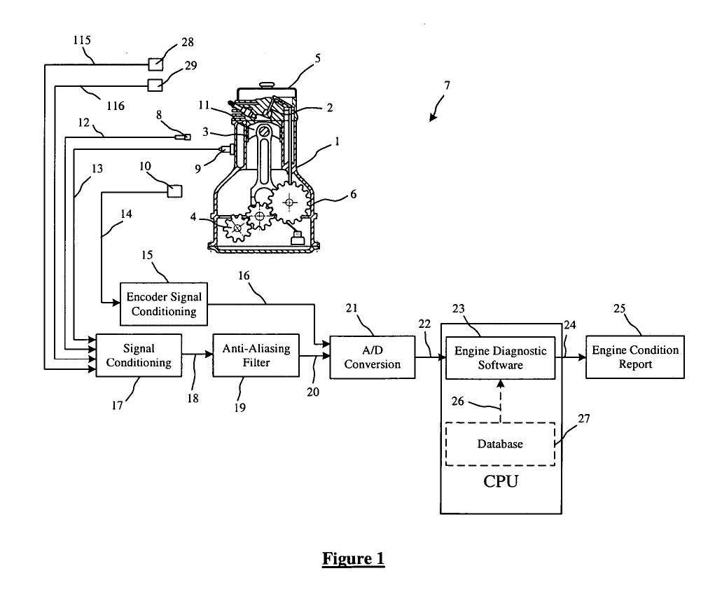

FIG. 1 illustrates an engine diagnostic system 7 for detecting faulty mechanical parts in an internal combustion engine 1. Briefly, the system includes at least one vibration sensor (accelerometer) 9, at least one sound sensor (microphone) 8, encoder 10, at least two vacuum sensors 28, 29 (for cold testing), signal conditioning and filtering circuits 15, 17, 19, A/D signal converter 21, and engine diagnostic software 23. Although three internal components of an internal combustion engine; namely, valves 2, gears 4, and oil rings 3, are illustrated as examples, it should also be understood that more engine components can be added once their distinguishing feature frequencies are detected by sensors 8 and 9.

At the quality assurance cell, the subject engine is first placed at a designated place and the encoder 10 and the vibration sensor 9 are clamped to the engine. In the cold test case, the encoder 10 is preferably attached permanently to the electric motor (not shown). Also, in the cold test case, the vacuum sensors 28 and 29 are mounted to the engine cylinder intake and exhaust ports using special adapters (not shown). In both cold and hot tests, the vibration sensor 9 is preferably clamped at a critical location that transmits apparent responses from all engine mechanical components of interest. The number of vibro-acoustic sensors and their locations are defined throughout off-line time-frequency analysis of the particular engine components.

At a running condition, moving mechanical parts (e.g., 2, 3, 4) within the engine 1 convert part of their kinetic energies into vibration and sound that is transmitted to the sensors 8 and 9 through the engine casing 6 and cover 5. Also in the cold test case, vacuum fluctuates at the intake and exhaust ports due to piston movement and valve opening and closing. The vacuum fluctuations are sensed using vacuum sensors 28 and 29. Electric signals 12, 13, 115, and 116 that are generated by the sensors are passed to a signal conditioning circuit 17. Conditioned signals 18 are preferably passed through an anti-aliasing filter 19 to attenuate any high frequency noises and prevent aliasing effects that may result during the analog to digital conversion. The encoder 10 generates one pulse every time engine crankshaft completes one rotation (or two pulses for one engine cycle). The pulse location is set to coincide with the TDC (top dead center) position of the engine piston 11 (piston number 1 in multi-cylinder engines). The encoder signal 14 is modified in 15 such that only one pulse is generated for one engine cycle. This pulse is then used to trigger an A/D converter 21 at the same TDC of the engine cycle (or the 1st cylinder engine cycle), e.g., the TDC that precedes the piston intake stroke. Once the engine reaches steady state speed, the A/D converter 21 samples and collects the encoder signal 17 and the sensors filtered signals 20 for at least 20 engine cycles to accommodate any possible variations in the produced signals. The sampled data 22 is then passed to a CPU that runs the engine diagnostic software 23 for analysis and component condition assessment. The software 23 incorporates predefined constants preferably maintained in database 27. These constants include, for example, engine type, number of cylinders, number of sensors, with others. Results 24 are then summarized in an engine condition report 25. The CPU may be a general purpose computer suitably programmed to perform the functions described herein and includes any necessary additional hardware.

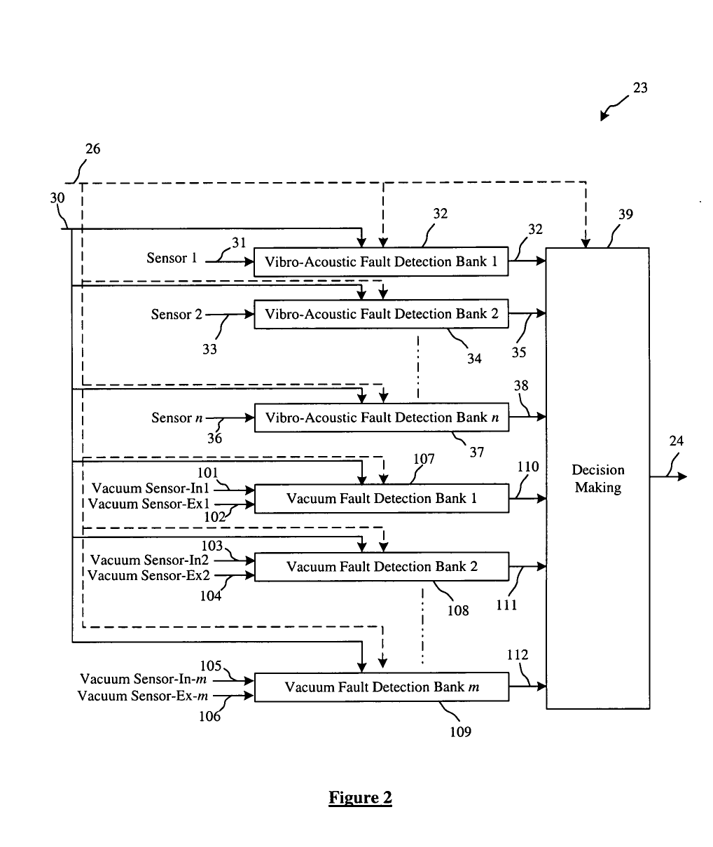

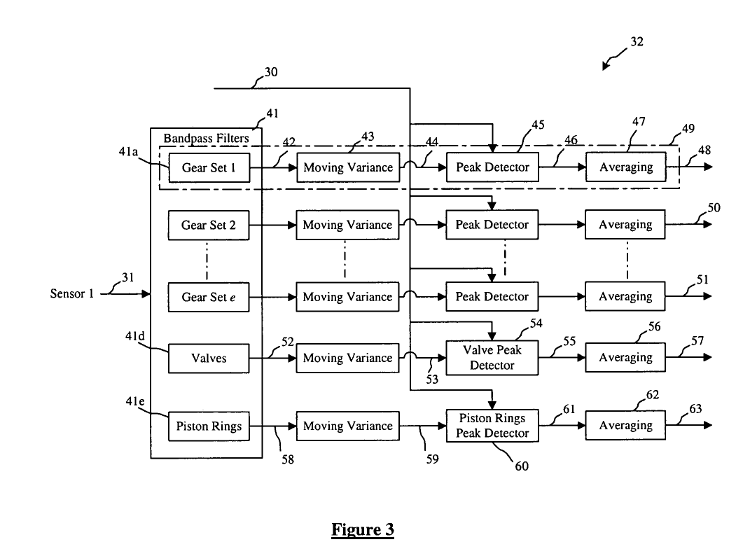

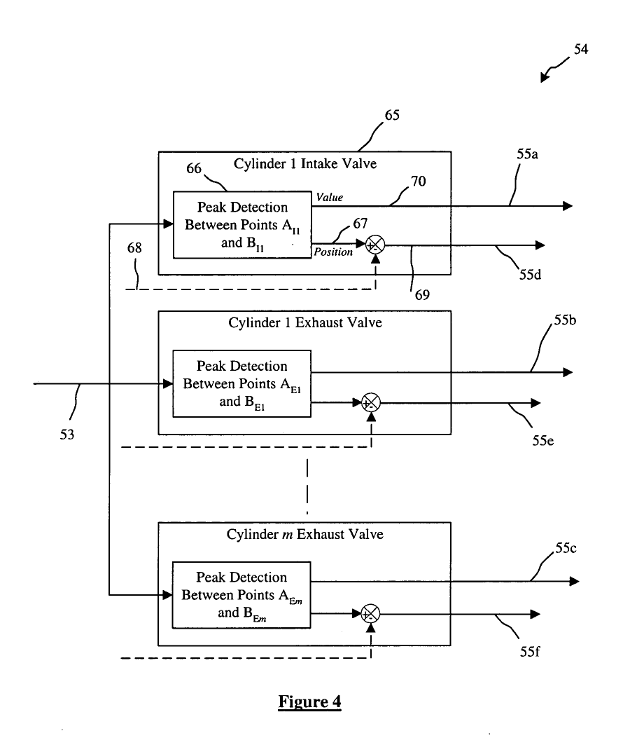

Referring to FIG. 2, the engine diagnostic software 23 is schematically illustrated. The diagnostic software 23 preferably includes a number of structurally identical vibro-acoustic fault detection banks 32, 34, 37, a number of vacuum fault detection banks (one for each cylinder) 107, 108, 109, and a decision making step 39. Each vibro-acoustic fault detection bank 32, is set to receive data from a single sensor (either a microphone or an accelerometer) 31, and the encoder signal 30. Similarly, each vacuum fault detection bank 107, is set to receive data from intake and exhaust vacuum sensors 101, 102 and the encoder signal 30. Also, each fault detection bank retrieves its predefined constants from the database 27 through 26. Examples of these fault detection banks 32 and 107, are detailed in FIG. 3 and FIG. 4, respectively.

FIG. 3 details a vibro-acoustic fault detection bank 32 which comprises a number of fault detection modules 49. Each fault detection module is assigned for a specific internal mechanical component in the engine, for example, fault detection module 49 is assigned to detect damage in gear set 1. FIG. 3 names several gears, valves, and oil piston rings as found to be critical for some IC engine manufacturers, however, more components can be added. Each fault detection module 49, includes a bandpass filter 41, a module for evaluation of the signal moving variance 43, moving variance peak detector 45, and a peaks averaging unit 47. The parameters (e.g. cut of frequencies, filter order, the size of the moving variance window, etc.) are preferably maintained in the database 27 (FIG. 1). The frequency band of each filter 41 is determined throughout a time-frequency analysis of the engine sound and vibration. Each band is selected such that signal to noise ratio of the specific engine element is maximized (noise in this context means any signal other than the response signal of the component of interest). For example, in a small single piston engine, the gear set filter band is set between 1000 Hz to 4000 Hz, however, the valves filter band limits are set at 11000 Hz to 13000 Hz. Moreover, in situations where two component responses are overlapped in frequency domain, additional sensor is preferably added and placed close to one of the components.

Each filtered signal 42, is passed to a moving variance calculation step 43, to evaluate the moving variance of the entire signal. The moving window size and overlap are retrieved from the database 27. These parameters are selected to reflect the filtered signal power variations through out the engine cycle. For example, for the gear sets in a single piston engine, the window size can be set to be about tenth of the engine cycle period length and with an overlap of about 75%. The moving variance value array 44, is then passed to a peak detector 45, to detect the peak values of the moving variance within each engine cycle. The array of the peak values 46 contains at least 20 peaks (the same number of the consider engine cycles). The array 46 is then passed to the averaging step 47 to compute the peaks mean value 48. Each mean value 48, reflects the specific engine component condition assessment as being estimated using data from sensor 1.

Now referring to FIG. 4, the valve peak detector 54 is different from those used for the gears 45 of FIG. 3. The valve peak detector 54 includes peak detector for each valve in the engine. Since the closing time of each valve is known from engine specifications, each valve peak detector searches for the moving variance peak values within ±25° of the ideal peak location of the closing time of the specific valve. The array 55a contains at least 20 peak values that are related to cylinder 1 intake valve. Advancement or retardation in valve closing time is also calculated using the peak position 67, and the ideal valve closing time 68 as read from the database 27. Valve response peak arrays 55a, 55b, etc, and valve timing arrays 55d, 55e, etc, are passed to step 56 (FIG. 3) for calculating the mean value of each array. The array of the mean values 57 includes data that reflects the clearance estimation of each valve and the mistiming indication from each valve.

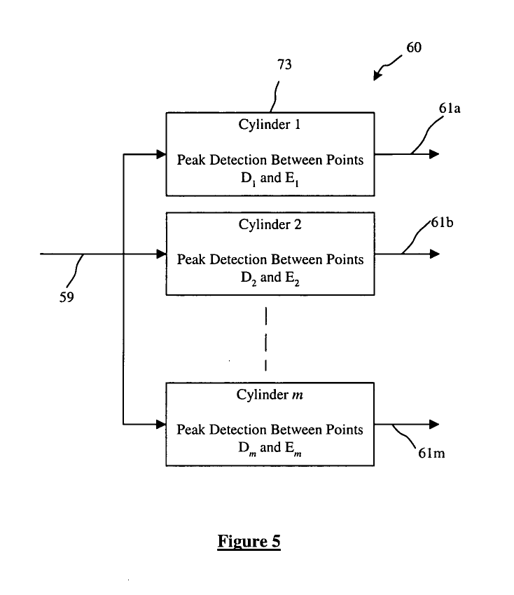

Referring to FIG. 5, the oil ring peak detector 60 is different from those used in the gears or the valves 45, 54 (FIG. 3). The oil ring peak detector 60 includes a number of peak detectors each one assigned for a specific cylinder 73. Since a piston oil ring generates a signal while scraping the engine cylinder, high responses are expected at high scraping speed which coincides with the piston maximum speed. The piston maximum speed occurs in the midway between the TDC and the BDC. The oil ring peak detector 73, searches for the moving variance peak values within ±25° of the maximum piston speed range, i.e. between 65° and 115° of the crankshaft angular rotation (as measured from the piston TDC). The array 61a contains at least 20 peak values that are related to cylinder 1 piston oil ring. Oil ring response peak arrays 61a, 61b, etc, are passed to step 62 of FIG. 3 for calculating the mean value of each array. The array of the mean values 63 of FIG. 3 includes data that reflects the presence of each oil ring.

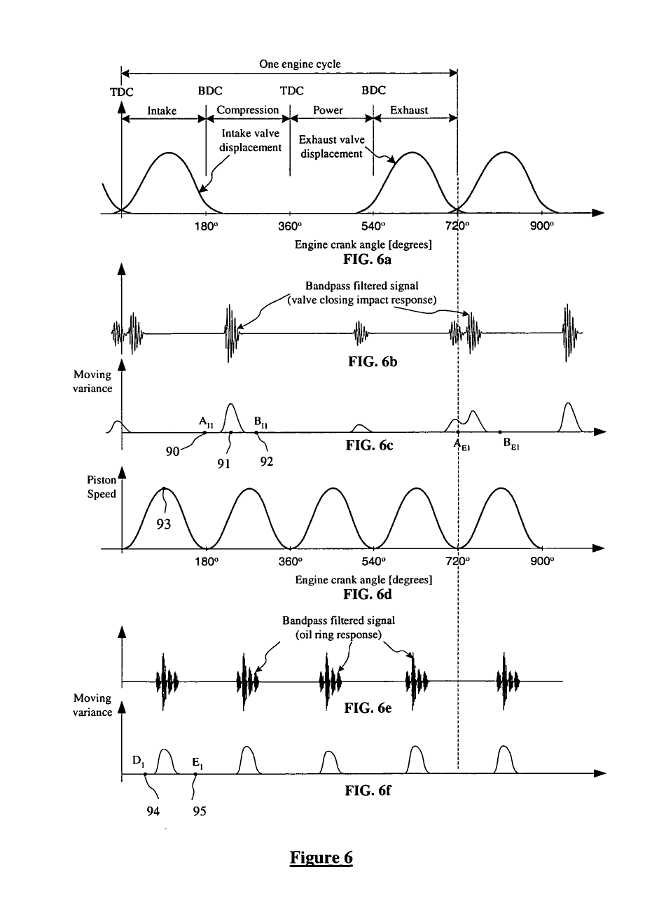

FIG. 6 is a graphical illustration of the piston and valve movements, of a single piston engine, and their responses. FIG. 6a shows the valve displacement curves as being measured with respect to the crankshaft angular rotation. Opening and closing valve events generate impacts which are found to be consistent with the valve clearance size. The impacts can be easily seen by passing the sensed vibration or sound signal through a bandpass filter 41d (FIG. 3). FIG. 6b shows a graphical illustration of the filtered signal 52 (FIG. 3). In this present invention the valve closing event is used as the diagnostic measure for the valve clearance estimation. FIG. 6c shows the moving variance of the signal in FIG. 6b. The points 90 and 92 are used as search range limits for the valve peak detector of the intake valve 66 (FIG. 4). The peak of properly timed valve 91 is used as a reference to measure valve mistiming and preferably maintained in the database 27 (FIG. 1). FIG. 6d graphically illustrates the piston speed as it moves up and down in stroke motion. The peak 93 occurs in the midway between the piston TDC and BDC. FIG. 6e is a graphical representation of the filtered piston ring response 58 (FIG. 3). FIG. 6f is the moving variance calculator output 61 (FIG. 3). Points 94 and 95 are used as search range limits for the ring peak detector of the first cylinder piston.

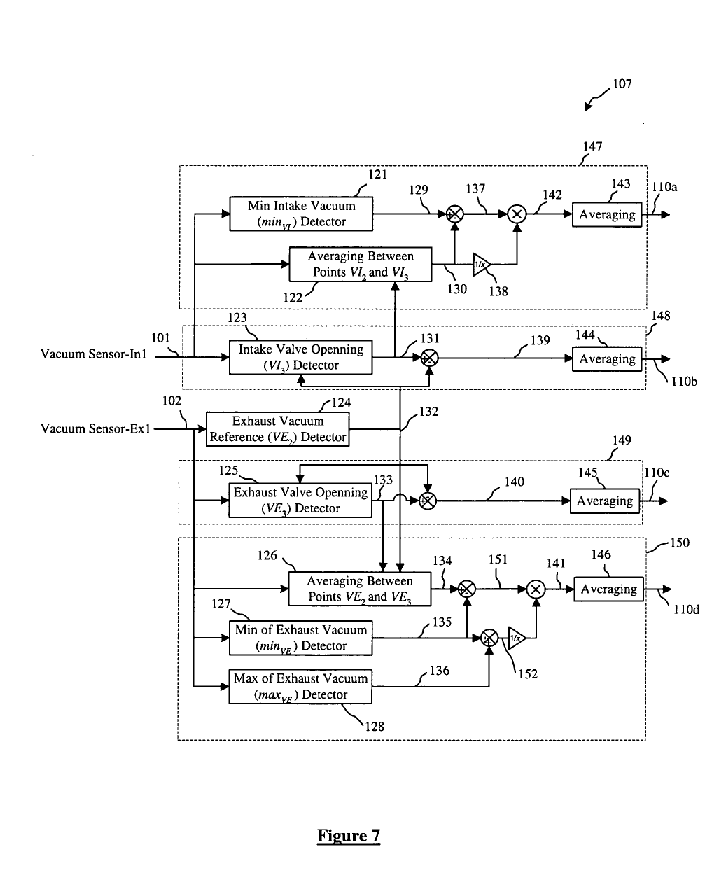

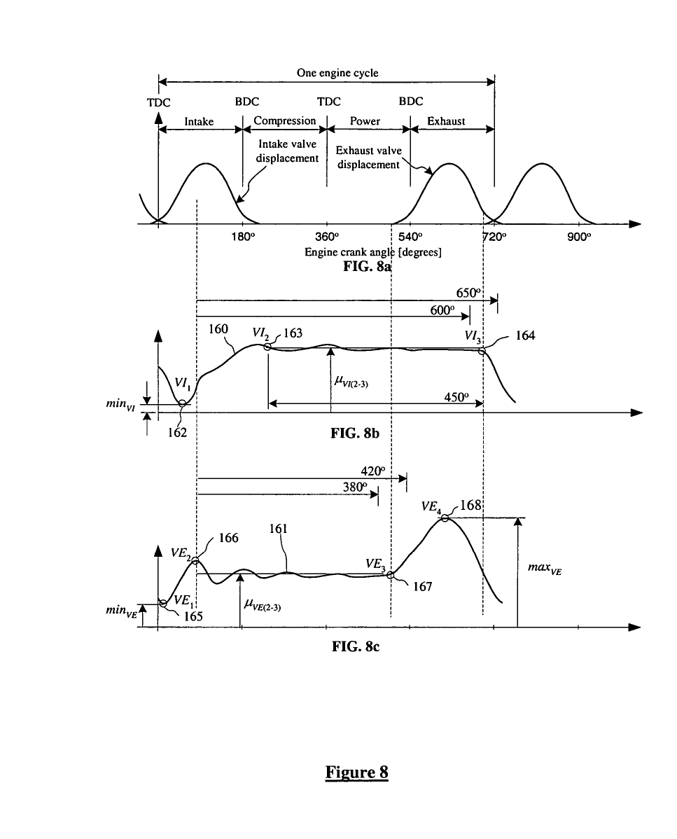

FIG. 7 details a vacuum detection bank 107 which assigned for cylinder no. 1 and includes four vacuum fault detection modules 147, 148, 149, 150. The module outputs include the intake valve timing measure 110a, the intake valve clearance measure 110b, the exhaust valve clearance measure 110c, and the exhaust valve timing measure 110d. Exhaust vacuum signal 102 is first passed through a reference detector 124 which detects the first peak after the minimum exhaust vacuum, point VE₂ 166 (FIG. 8), in each engine cycle. The angular position of Point VE₂ is found to be consistent with the piston position and regardless of the valve clearance or timing. Array 132 contains 20 timing references (measured in crankshaft angular position) of all consider 20 engine cycle signals. The intake clearance detection module 148 includes an intake valve opening detector 123 to detect points VI₃ 164 (FIG. 8) throughout the entire signal of the 20 engine cycles and using the information from array 132. The valve opening detector 123 monitors the vacuum signal drops between 600° to 650° after each reference value from array 132. The resultant array 139 includes elements representing intake valve clearance measures for the considered 20 engine cycles. The array 139 is then passed through an averaging step 144 to compute the mean intake clearance measure 110b.

The exhaust clearance detection module 149 includes an exhaust valve opening detector 125 to detect points VE₃ 167 (FIG. 8) throughout the entire signal of the 20 engine cycles and using the information from array 132. The valve opening detector 125 monitors the vacuum signal increase between 380° to 420° after each reference value from array 132. The resultant array 140 includes elements representing exhaust valve clearance measures for the considered 20 engine cycles. The array 140 is then passed through an averaging step 145 to compute the mean exhaust clearance measure 10c.

The intake timing detection module 147 includes minimum vacuum detector 121 and an averaging step 122 that averages the vacuum signal 101 samples that are available between points VI₂ and VI₃, 163 and 164 (FIG. 8) respectively, in each engine cycle throughout the intake vacuum signal. A non-dimensional timing measure array 142 is computed by subtracting the elements of array 130 from the elements of array 130 and divides the resultant array elements by the elements in array 130. Array 142 is then passed through an averaging step 143 to compute the mean intake timing measure 110a.

The exhaust timing detection module 150 includes minimum exhaust vacuum detector 127, maximum exhaust vacuum detector 128, and an averaging step 126 that averages the exhaust vacuum signal 102 samples between points VE₂ and VE₃, 166 and 167 (FIG. 8) respectively. Array 131 contains elements represent the difference between the elements in the exhaust vacuum average array 134 and the elements in the exhaust minimum vacuum array 135. Array 152 contains elements represent the difference between the elements in the exhaust maximum vacuum array 136 and the elements in the exhaust minimum vacuum array 135. A non-dimensional timing measure array 141 is computed by dividing the elements in array 151 by the elements in array 152. Array 141 is then passed through an averaging step 146 to compute the mean exhaust timing measure 110d.

FIG. 8 is a graphical illustration of the valve movements of a single piston engine and vacuum signals of both intake and exhaust engine ports. FIG. 8a shows the valve displacement curves as being measured with respect to the crankshaft angular rotation. Opening and closing valve events alter the waveform shapes of the cylinder intake and exhaust vacuums. FIG. 8b shows the intake vacuum waveform 160 and FIG. 8c shows the exhaust vacuum waveform 161. Valve openings 164, 167 can be easily seeing in FIG. 8b and FIG. 8c respectively.

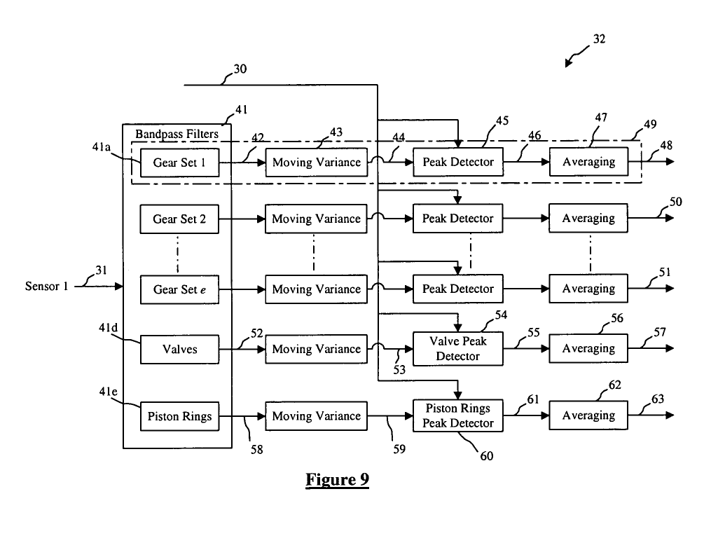

Now referring to FIG. 9, the decision making step 39 comprises of a number of component condition inferences 77, 78, 84, etc. Each inference module is dedicated for a single component of interest. For example, inference 77 receives gear set 1 fault assessment from all possible used sensors through 48, 75, and 76. The inference inputs 48, 75, and 76 are then weighted according to their sensor type and sensor location from the specific component. Techniques such as fuzzy logic can be used here to reach a conclusive decision 24a, about the specific engine component condition. Decisions from each inference are then summarized in engine condition report 25 (FIG. 1). Another example is the inference 78 which is dedicated for the intake valve of cylinder no. 1 and receives the intake valve clearance assessment 55a, 80, 81 from vibro-acoustic sensors and also clearance measure 110b from the intake vacuum sensor.

It should be noted here that, although, the present invention is illustrated as a diagnostic system being used in a quality assessment cell in an IC engine assembly line, the present invention can be easily used for IC engine condition monitoring as well.

It is understood that various other modifications will be apparent to and can be readily made by those skilled in the art without departing from the scope and spirit of this invention. Accordingly, the following claims should be studied to determine the true scope and content of this invention.

What is claimed is:

1. An internal combustion engine diagnostic method including the steps of:
a. receiving engine signals by means of data acquisition system; and
b. determining the engine condition based upon said step a.

2. The method as recited in claim 1, wherein said step a. further includes the steps of:
c. receiving engine sound by means of at least one microphone;
d. receiving engine vibration by means of at least one accelerometer;
e. receiving engine cycle reference signal by means of an encoder; and
f. receiving engine vacuum signals by means of at least two vacuum sensors.

3. The method of claim 1, further including the steps of:
c. passing only a frequency range that is most influenced by said a particular gear set of interest;
d. evaluating a moving variance based upon said step c.;
e. evaluating a peak value based upon said step d and within each engine cycle period;
f. determining an average value based upon said step e.

4. The method of claim 1, further including the steps of:
c. passing only a frequency range that is most influenced by a particular valve;
d. evaluation of the moving variance based upon said step c;
e. evaluating a peak value based upon said step d. and between two limits around a particular valve closing time for each engine cycle; and
f. determining an average value based upon said step e.

5. The method of claim 4 wherein the two limits in said step e. are determined based on an engine type, a kind of valve, an cylinder number, and an engine cycle reference signal from an encoder.

6. The method of claim 1, further including the steps of:
c. passing a selected frequency range that most influenced by a particular piston oil ring;
d. determining a moving variance based upon said step c;
e. determining a peak value based upon said step d. and between two limits around a maximum speed for the particular piston oil ring for each engine cycle; and
f. determining an average value based upon said step e.

7. The method of claim 6, wherein the two limits are determined based on an engine type, a cylinder number, and an engine cycle reference signal from an encoder.

8. The method of claim 1 further including the steps of:
c. detecting a minimum vacuum value of an intake vacuum waveform for each engine cycle;
d. calculating an average value of the intake vacuum waveform between two limits and for each engine cycle;
e. calculating a non-dimensional measure of the intake valve timing for each engine cycle based upon said steps c. and d.; and
f. determining an average value based upon said step e.

9. The method of claim 8 wherein said two limits are identified by an intake valve opening time and a point preceding it by 450 degrees of engine crankshaft rotation.

10. The method of claim 9 further including the step of determining the intake valve opening time based upon an intake vacuum signal.

11. The method of claim 1 further including the steps of:
c. detecting an intake valve opening time for each engine cycle based upon an intake vacuum signal and a piston position reference as measured from an exhaust vacuum;
d. calculating a difference between the intake valve opening time and the piston position reference for each engine cycle; and
e. determining an average value based upon said step d.

14. The method of claim 1 further including the step of calculating a non-dimensional measure of intake valve timing by subtracting a minimum intake vacuum value from an average intake vacuum value and dividing the result by the average intake vacuum value.

15. The method of claim 1 further including the steps of:
c. detecting an exhaust valve opening time for each engine cycle based upon an exhaust vacuum signal and a piston position reference;
d. calculating a difference between the exhaust valve opening time and a piston position reference for each engine cycle; and
e. determining an average value based upon said step d.

16. The method of claim 1 further including the steps of:
c. detecting a minimum exhaust vacuum of a exhaust vacuum waveform for each engine cycle;
d. detecting a maximum exhaust vacuum of the exhaust vacuum waveform for each engine cycle;
e. calculating an average value of the exhaust vacuum waveform between two limits for each engine cycle; and
f. calculating a non-dimensional measure of exhaust valve timing for each engine cycle based upon said steps c., d., and e.
g. determining an average value based upon said step f.

17. The method of claim 16 wherein said two limits are identified by an exhaust valve opening time and the piston position reference, for each engine cycle, the exhaust valve opening time determined based upon an exhaust vacuum signal and a piston position reference.

18. The method of claim 16, further including the step of calculating the non-dimensional measure of the exhaust valve timing by dividing a difference between the average exhaust vacuum and the minimum exhaust vacuum by a difference between the maximum exhaust vacuum and the minimum exhaust vacuum.

19. An internal combustion engine diagnostic system comprising:
a data acquisition system; and
an engine diagnostic computer determining the engine condition based data from the data acquisition system.

20. The system of claim 19 further including:
at least one microphone generating sound signals based upon engine sound;
at least one accelerometer generating vibration signals based upon engine vibration;
an encoder generating an engine cycle reference signal; and
at least two vacuum sensors generating engine vacuum signals.

21. The system as recited in claim 20, wherein the engine diagnostic computer further includes:
a plurality of vibro-acoustic fault detection banks, each vibro-acoustic fault detection bank being dedicated to receive data from a single one of the at least one microphone or at least one accelerometer; and
a plurality of vacuum fault detection banks, each vacuum fault detection bank being dedicated to receive data from the at least two vacuum sensors, the at least two vacuum sensors connected to one cylinder.

22. The system of claim 21 wherein each of said plurality of vibro-acoustic fault detection banks comprises of a number of vibro-acoustic fault detection modules, each assigned for a particular engine component of interest.

23. The system of claim 22, wherein at least one of the vibro-acoustic fault detection modules is assigned for a gear set and includes a digital filter that passes only a frequency range that most influenced by the assigned gear set, the at least one vibro-acoustic fault detection module including a module for evaluation of the moving variance based upon the filtered frequency range, wherein the at least one vibro-acoustic fault detection module evaluates a peak value based upon the moving variance within each engine cycle period and determines an average value based upon the evaluation of the peak value.

24. The system of claim 22 wherein at least one of the vibro-acoustic fault detection modules is assigned for a valve element and includes a digital filter that passes only a frequency range that is most influenced by said the assigned valve element, the at least one vibro-acoustic fault detection module evaluating a moving variance based upon the filtered frequency range, evaluating a peak value based upon the moving variance between two limits around a valve closing time for the assigned valve for each engine cycle, the at least one vibro-acoustic fault detection module determining the average value based upon the peak value.

25. The system of claim 24, wherein said two limits are determined based on an engine type, a kind of valve, a cylinder number, and a engine cycle reference signal as determined from the encoder.

26. The method of claim 22, wherein at least one of the vibro-acoustic fault detection modules is assigned to a piston oil ring element and includes a digital filter that passes only a frequency range that is most influenced by the assigned particular piston oil ring, the at least one vibro-acoustic fault detection module determining a moving variance based upon said the filtered frequency range, the at least one vibro-acoustic fault detection module determining a peak value based upon said moving variance and between two limits around a particular piston maximum speed for each engine cycle, the vibro-acoustic fault detection module determining the average value based upon moving variance.

27. The system of claim 26 wherein the two limits are determined based on an engine type, a cylinder number, and an engine cycle reference signal from the encoder.

28. The system of claim 21 wherein each vacuum fault detection bank includes:
a piston position reference detector determining piston position reference based upon an exhaust vacuum signal;
a vacuum fault detection module for intake valve timing;
a vacuum fault detection module for intake valve clearance;
a vacuum fault detection module for exhaust valve clearance; and
a vacuum fault detection module for exhaust valve timing.

29. The system of claim 28, wherein the piston position reference is expressed in terms of the engine crankshaft angular rotation.

30. The system of claim 28 further including:
a minimum intake vacuum detector that detects the minimum vacuum value of the intake vacuum waveform for each engine cycle, the engine diagnostic computer calculating the average value of the intake vacuum waveform between two limits and for each engine cycle, the engine diagnostic computer calculating a non-dimensional measure of the intake valve timing for each engine cycle and based upon said the minimum vacuum value and the average value of the intake vacuum waveform.

31. The system of claim 28 further including:
an intake valve opening time detector for each engine cycle and based upon an intake vacuum signal and the piston position reference, the engine diagnostic computer calculating a difference between the intake valve opening time and the piston position reference for each engine cycle.
